(19) United States
(12) Patent Application Publication
(10) Pub. No.: US 2024/0049910 A1
(43) Pub. Date: Feb. 15, 2024

(54) COOKING EXPANSION MODULE

(71) Applicant: Sunbeam Products, Inc., Atlanta, GA (US)

(72) Inventors: George Hardin, Hattiesburg, MS (US); Michael Dillane, Hoboken, NJ (US); Joseph C. Spencer, Boynton Beach, FL (US); Peter Weremchuk, Hoboken, NJ (US); Tom Guyett, Boynton Beach, FL (US); Eliott G. Copier, Grand Rapids, MI (US); William Michael Kennedy, Wellington, FL (US)

(21) Appl. No.: 18/264,620

(22) PCT Filed: Feb. 8, 2022
(86) PCT No.: PCT/US22/15601

§ 371 Date: Aug. 8, 2023

Related U.S. Application Data
(60) Provisional application No. 63/146,754, filed on Feb. 8, 2021.
(60) Provisional application No. 63/215,545, filed on Jun. 28, 2021.
(60) Provisional application No. 63/234,958, filed on Aug. 19, 2021.

(51) Int. Cl. A47J 37/06; A47J 27/13

(52) U.S. Cl. CPC A47J 37/0664; A47J 37/0641; A47J 37/0694; A47J 37/0635; A47J 27/13

(57) ABSTRACT

An add-on expansion module is provided that can be used with existing cooking appliances in order to allow the cooking appliance to perform multiple cooking functions. The module is designed to fit on top of a cooking appliance's vessel, with the cooking appliance's lid able to fit on the module. Therefore, the module does not require an additional lid to store. The module includes a support structure that may include one or more housings in which cooking accessories may be retained. The cooking accessories may carry out many cooking functions, including steam, air fry, smoke, sous vide, timed ingredient add, and food processor functions. The module further includes two openings that allow a user to access the contents of the vessel during the cooking process, for example to add or stir ingredients, without having to remove the module.

### CROSS-REFERENCE TO RELATED APPLICATIONS

This application claims priority to U.S. Provisional Patent Application Ser. No. 63/146,754, filed on Feb. 8, 2021, entitled “ONE POT COOKING AIR FRY EXPANSION MODULE,” currently pending, U.S. Provisional Patent Application Ser. No. 63/215,545, filed on Jun. 28, 2021, entitled “GRILL MODULE,” currently pending, and U.S. Provisional Patent Application Ser. No. 63/234,958, filed on Aug. 19, 2021, entitled “ADD-ON EXPANSION MODULE FOR ONE POT COOKER,” currently pending, the entire disclosures of which are incorporated herein by reference.

### FIELD OF THE INVENTION

The present invention relates generally to a cooking expansion module that can be used in association with a one pot cooker to provide several cooking functions. The invention allows a user to modify the one pot cooker to perform additional functions without requiring an extra lid to be used with the one pot cooker.

### BACKGROUND OF THE INVENTION

A cooking appliance is a very common and reliable appliance found in many homes. Such cooking appliances may be used for cooking meals, often unattended by the user during the cooking cycle. The appliances are typically slow cook earthenware or pressure-cooking devices. Because users often carry out various cooking functions with their cooking appliances, many users own multiple appliances to carry out various cooking functions. Thus, a user may own, for example, a pressure cooker, slow cooker, air fryer, rice cooker, food processor, smoker, etc., all as standalone devices.

Having so many cooking appliances occupies a large amount of space in already-crowded kitchens where storage space is at a premium. Some consumers therefore buy so-called “multi-function” cooking devices that can carry out more than one cooking function such as those described above. This eliminates the need for another appliance to be purchased that would require more counter space and storage area in the kitchen.

Unfortunately, few multifunction cooking devices on the market can perform so-called conductive cooking (e.g., pressure cooking, slow cooking, rice cooking, etc.) as well as air frying. Those that can perform all of these functions require a separate lid for air frying as compared to conductive cooking. For example, a pressure-cooking appliance needs complete airtightness in the cooking vessel, and an air fryer appliance requires airflow through and around the lid. Further, pressure cooking and slow cooking often creates a great deal of moisture within the cooking appliance, which can be harmful to air frying components over time. When a multicooker needs multiple lids to carry out multiple cooking functions, storage in a kitchen becomes a problem. Multi-cooking lids, especially those with the components necessary to carry out air frying, are bulky on their own. Storing multiple lids is even more unwieldly.

Furthermore, products on the market that act as indoor grilling devices and aim to simulate the cooking experience of an outdoor gas or charcoal grill may be undesirable. Some examples of indoor grilling devices introduce another “single-purpose” appliance to a kitchen, which can be problematic in smaller kitchens. Such single-purpose appliances are typically simply formed from two conductive heating “grill plates” that can be placed adjacent one another with foodstuffs therebetween to cook the foodstuffs. Although they may do a suitable job of searing foods, these cookers fail to reproduce the air circulation that traditional outdoor grills create.

Other inductive multi-cookers, or even multi-cookers with an air fry feature, aim to perform grilling functions by including a grill plate that can leave grill marks on foodstuffs being cooked. Not only do those cookers require an extra lid as set forth above, but grill plates in those single pot cookers may not include slots through which excess fats and oil may drip. As a result, foods being cooked on such plates may sit it their fats and oils during cooking. This can increase the likelihood that the foods being “grilled” are overcooked, and may introduce too much fat into the food being cooked.

It is the combination of air circulation and a traditional grill grate having slots that provides the “grilling experience,” and one pot cookers on the market today simply fail to easily and accurately reproduce the cooking that traditional grills offer.

Moreover, existing multifunction cooking devices fail to carry out multiple cooking functions during the same cooking “session.” For example, they cannot automatically add an ingredient at a predetermined time in the middle of a slow cook. For some recipes, it is best if some ingredients are added at the beginning of the cooking process, while others could be added later in the process. It is inconvenient to stop or otherwise interrupt the cooking process to add ingredients mid-cook.

### SUMMARY OF THE INVENTION

The invention subject of this application is an air fry expansion module configured to be used with an existing cooking appliance to allow the appliance to function as an air fryer. The air fry module is not, and does not function as a lid, meaning that it does not completely cover the cooking vessel. Put another way, if the module is placed on a cooking vessel, direct access is provided to the contents of the vessel without having to remove the module. The module can accommodate an existing lid of a user's cooking appliance.

The module preferably includes a lip member that extends downwardly from the module and is configured to sit within a flange formed in a top portion of a cooking vessel such as those available in the market today. An upper portion of the module may include a flange that is substantially similarly sized and shaped to the flange formed in the top portion of the cooking vessel. That way, when the module is used, it may sit in the flange of the vessel, while the lid typically used with the cooking appliance may sit in the flange formed in the top portion of the cooking vessel.

A support structure is provided that extends across the module in which various components used to carry out the air frying cooking function may be housed. For example, the support structure may include a motor, heating element, fan, ducting, and a control panel or system to operate the same. The support structure may generally be comprised of a center housing and at least one arm members extending radially outwardly therefrom toward a structural wall member that surrounds the support. As such, open portions are provided between the arm member(s) and the structural wall member. The open portions make the module substantially “open” in the locations of the open portions so that ingredients can be added during a cooking cycle.

The module provides increased performance and versatility features as compared to the cooking appliances available in the market. For example, by not requiring an extra lid, the module may be easily and compactly stored. It also includes enhanced performance capabilities provided by a multi-stage cooking. For example, two cooking stages may be carried out when the module is used, such as an air frying cook followed by a conductive slow cook. The open top also allows ingredients to be added during the cooking cycle.

The air fry expansion module can be used in conjunction with a grill module that may be placed on a bottom surface of the cooking vessel. Alternatively, the expansion module may be attached to or otherwise engaged with a top surface of the cooking vessel. When a heater is activated and the unit is in the “air fry” or even a simple “grill” (or other) mode, the grill module allows an operator to perform grilling functions using the single device that is described herein. The grill module includes each of a grated grill rack for supporting the food and a reflector that helps direct energy and air. The reflector preferably sits on the bottom of the cooking vessel, and the grate is positioned on the reflector. The reflector may be placed at variable distances away from the bottom of the vessel, for example, by using standoff feet. The grill rack similarly may be distanced from the reflector via standoff feet at variable distances.

In another embodiment, various housings provided in the support structure may each receive and contain an accessory that can be used during a cook cycle. In an embodiment where the support structure includes three housings, each of the housings may contain three separate (or in some cases two or more of the same) accessories. For example, a first housing may contain a “smoker” accessory that releases smoke or smoke flavoring during a cook cycle, a second housing may contain an air fryer accessory that carries out an air fryer cook mode during a cook cycle, and a third housing may contain a timed ingredient add accessory that releases an ingredient to the cooker at a prescribed time during a cook cycle. Each of the housings may include power contacts, ductwork, and the like, as appropriate, to provide infrastructure that supports function of the various accessories. The housings may further be in data communication with electronic and data components that can instruct the accessories to carry out their various functions at prescribed times. Examples of accessories that could be used in a housing of the appliance include, but are not limited to, steam, air fry, smoke, sous vide, timed ingredient add, and food processor accessories.

The module provides increased performance and versatility features as compared to the cooking appliances available in the market. For example, by not requiring an extra lid, the module may be easily and compactly stored. It also includes enhanced performance capabilities provided by a multi-stage cooking. For example, two cooking stages may be carried out when the module is used, such as an air frying cook followed by a conductive slow cook. The open top also allows ingredients to be added during the cooking cycle and for an operator to see the ingredients during the cook, unlike many cooking appliances.

### BRIEF DESCRIPTION OF THE DRAWINGS

For a better understanding of the present invention, reference may be made to the following accompanying drawings.

FIG. 1 is a front elevation view of an air fry expansion module constructed according to the teachings hereof with an existing lid of a cooking appliance attached thereto.

FIG. 2 is a rear elevation view of the air fry expansion module and lid of FIG. 1.

FIG. 3 is a bottom perspective view of the air fry expansion module and lid of FIGS. 1 and 2.

FIG. 4 is a perspective view of the air fry expansion module of FIGS. 1-3.

FIG. 5 is a top plan view of the air fry expansion module of FIGS. 1-4.

FIG. 6 is a bottom plan view of the air fry expansion module of FIGS. 1-5.

FIG. 7 is a cross-section perspective view of the air fry expansion module of FIGS. 1-6 and an associated cooking vessel with a grill module included therein.

FIG. 8 is a cross-section elevation view of the air fry expansion module, cooking vessel and grill module of FIG. 7.

FIG. 9 is a top plan view of an alternatively constructed multi-function cooking expansion module.

FIG. 10 is an exploded perspective view of the expansion module of FIG. 9.

FIG. 11 is a perspective view of several accessories that can be used with the expansion module of FIGS. 9 and 10.

FIG. 12 is a perspective view of the expansion module of FIGS. 9 and 10 being used with a cooking appliance, two steamer baskets, and a lid to carry out an example cooking process.

FIG. 13 is a top plan view of second embodiment of the expansion module of FIGS. 9 and 10.

FIG. 14 is a perspective view of the expansion module of FIG. 13.

FIG. 15 is a perspective view of crown members used to connect accessories of the expansion module of FIGS. 13 and 14 and 8 to a support structure of the expansion module.

FIG. 16 is a perspective view of a stir accessory that may be used with the expansion modules described herein.

FIG. 17 is a top plan view of yet another alternatively constructed expansion module constructed according to the teachings hereof.

### DETAILED DESCRIPTION OF THE INVENTION

An air fry expansion module 1 (hereinafter referred to simply as the “module 1”) is illustrated with a lid 5 from an existing cooking appliance coupled to the module 1. The module 1 allows an existing cooking appliance (not illustrated) to perform an air frying function in addition to its built-in cooking features (e.g., rice cooking, slow cooking, sautéing) without exchanging lids.

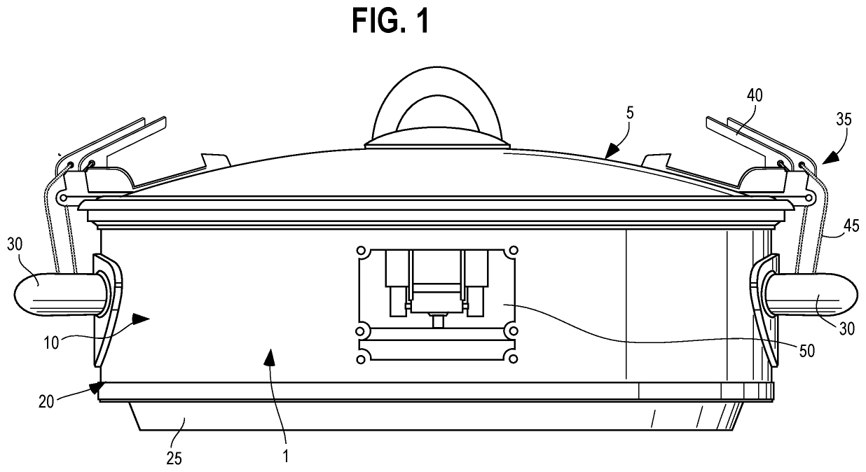

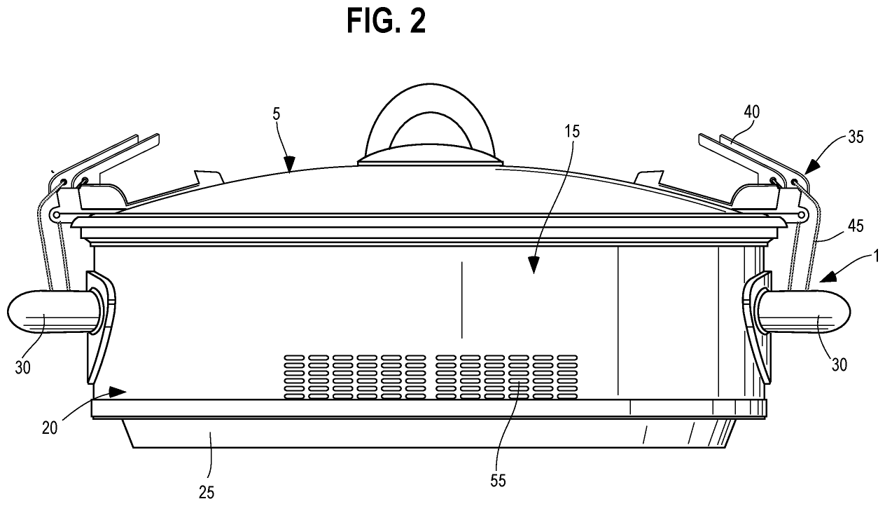

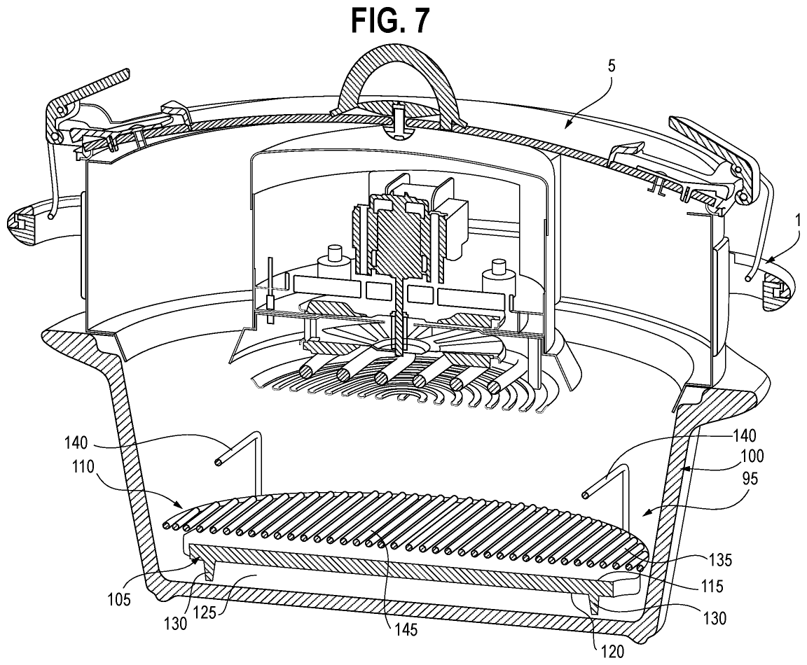

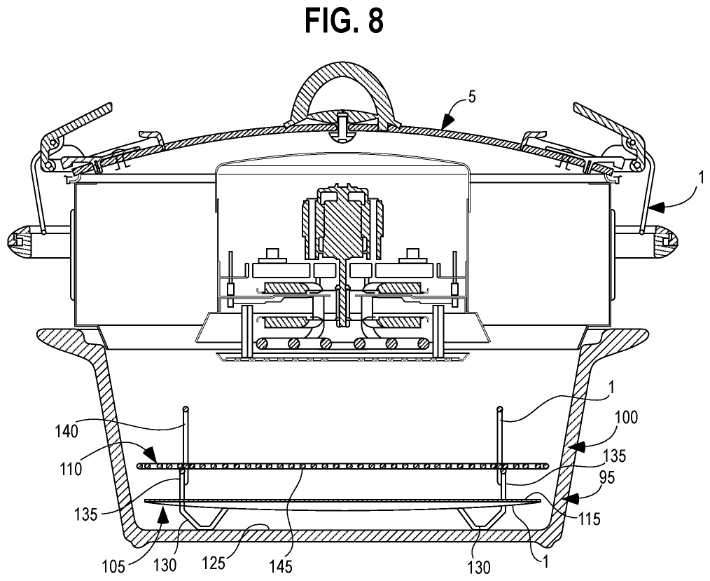

FIG. 1 illustrates a front side 10 of the module 1 and the lid 5, while FIG. 2 illustrates a rear side 15 of the module 1 and the lid 5. The module 1 also includes a structural outer wall that includes a downwardly and inwardly projecting lip member 25 that may rest in a flange in an opening of an existing cooking appliance's vessel (such as vessel 100 of FIGS. 7 and 8). The lip member 25 may take on a variety of sizes and shapes to be engageable with a variety of differently sized and shaped existing cooking appliances, or may not be present at all.

The module 1 also includes carrying handles 30 that may not only be used to carry the module 1, but also in some embodiments may include additional hardware by which the lid 5 may (or may not) be secured to the module 1. In some embodiments, the additional hardware is not part of the carrying handles. More particularly, many prior art lids 5 include a latch member 35 on both of its sides that may substantially align with hardware on the module 1 when the lid 5 is placed on the module 1. The latch members 35 may be engageable with such hardware (not shown) using a number of known or foreseeable methods or mechanisms. In the illustrated embodiment, the latch members 35 include a tab member 40 having hook members 45 that could be engageable with the module 1 when the tab members 40 are operated. The latch members 35 may be engaged to the module 1 when the module 1 is in use or simply when the module 1, lid 5, and cooking appliance are stowed away and not in use. The latch members 35 and/or handles 30 could also provide the function of a cord wrap feature for easy storage. In various embodiments, more or fewer latch members 35 may be provided.

The front side 10 preferably includes a control panel/display (not illustrated) that may also include controls themselves for operating the module 1 and carrying out an air frying function, or other functions built into the existing cooking appliance. The module 1 may interface with the electronics on the existing cooking appliance to control or enhance the underlying functionality thereof. The front side 10 as illustrated in FIG. 1 includes a recessed portion 50 in which the control display may be located when it is installed in the module 1.

The rear side 15 preferably includes a vented portion 55 in air communication with ducting in the module 1 through which air may enter or exit the module 1 when the air frying function is enabled. This may allow heat generated by the electronics and hardware components of the module 1 to be exhausted. The rear side 15 also preferably includes an exit port (not illustrated) for a power cord to exit the module 1. In alternative embodiments, the power source of the module 1 may integrate with the power source of the vessel using known or foreseeable methods such that only one power cord is used to operate the module 1 and the vessel. The power cord is preferably used to power various components housed in the module 1 that carry out the air frying function, as will be described below.

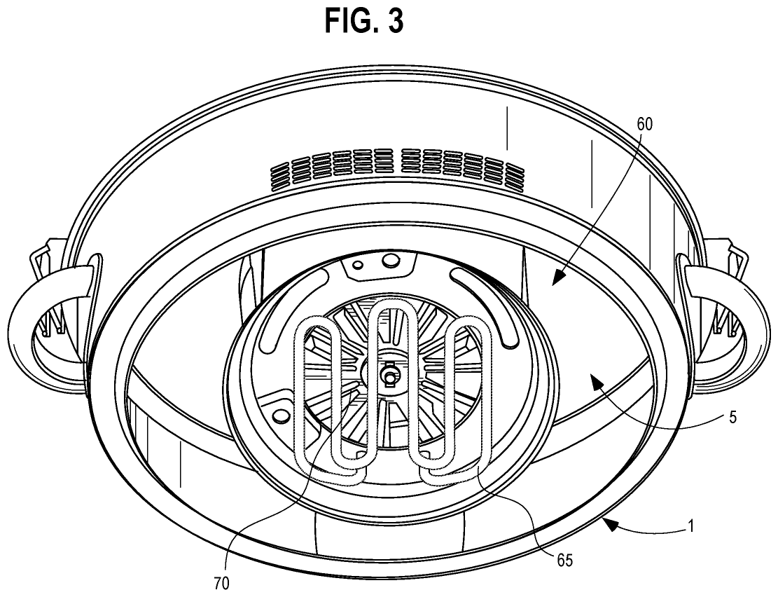

Some components that carry out the air frying function are illustrated in FIG. 3, which illustrates an underside 60 of the module 1 with the lid 5 attached thereto. In FIG. 3, a conductive heating element 65 is illustrated, along with a fan member 70 that circulates air heated by the heating element 65 to create a convective cooking environment. The fan member 70, like other fan members used in air frying functions, blows heat generated by the heating element 65 toward food being cooked in the cooking vessel of the cooking appliance. The heating element 65 and the fan 70 may come in a variety of sizes, shapes, and power parameters. In a preferred embodiment, the heating element 65 and the fan 70 may be operated by standard power from a wall outlet. Thus the power cord described above may be included, and may exit the module 1 via its rear side 15.

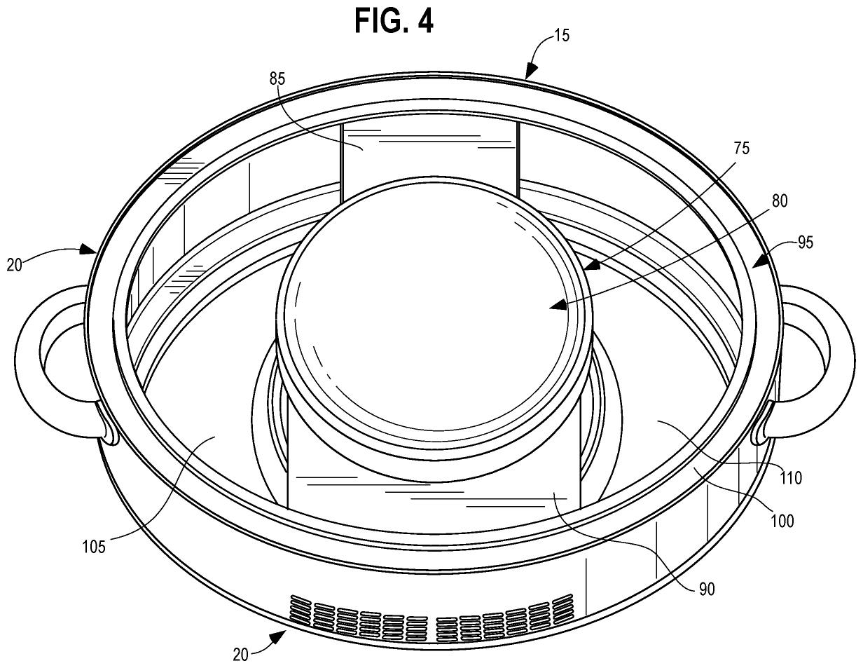

FIG. 4 illustrates the module 1 with the lid 5 removed therefrom. As shown, the module 1 includes an inner support structure 75 that may support the heating element 65 and the fan 70, and the mechanical and electronic components associated therewith. The inner support structure 75 generally may include a central housing unit 80 and at least one arm member(s), including, in an illustrative embodiment, two arm members 85, 90 that extend radially outwardly from the central housing unit 80 and attach to (or are integrally formed with) the outer wall 20. In one embodiment, the arm member 85 extends toward the front side 10, while the arm member 90 extends toward the rear side 15.

The central housing unit 80 is illustrated as generally circular in shape but could take on other shapes, such as ovals or rectangles. The central housing unit 80 preferably supports and houses or contains the heating element 65 and the fan 70, as well as the motor and air duct channels (not illustrated) that help carry out the air frying function. The air ducting preferably isolates the motor cooling airflow from the air fry convection airflow and may exit the module 1 via the vented portion 55. The air flow path within the module 1 and its inner support structure 75 may also incorporate an inlet channel around the control panel/display for thermal management. Air ducting may be positioned within one or both of the two arm members 85, 90.

The necessary cabling for controls and power may be located in the central housing unit 80 and in communication with the components needing power. The cabling for controls and power may also be located in at least one of the arm members 85, 90. Preferably, the power cord extends through one arm member 90 and exits through the power cord exit port described above. In the illustrated embodiment, the arm member 90 is wider than the arm member 85, though in alternative embodiments that may vary. Furthermore, in some embodiments, at least one of the arm members 85, 90, or the central housing unit 80, may include cooking accessories mounted thereon to carry out other cooking operations (e.g., smoking, steaming, grilling).

As illustrated in FIG. 4, a top portion 95 of the module 1 preferably includes a receiving flange portion 100 that is sized and shaped to receive an existing cooking appliance lid such as the lid 5 thereon. As such, the size and shape of the flange portion 100 may vary depending on the existing cooking appliance for which the module 1 has been designed to be compatible.

Openings are defined by the at least one arm member(s) and the outer wall. In the illustrative embodiment, two openings 105, 110 are defined by the arm members 85, 90 and the outer wall 20. As the outer wall 20 is preferably generally vertically oriented, it may not materially reduce the size of the openings 105, 110. The openings 105, 110 provide access to the cooking vessel when a lid such as the lid 5 is removed. A user can, for example, add ingredients during various times of the cooking process. It may also allow a user to inspect the cooking process and make adjustments such as mixing ingredients without substantially disturbing the appliance's cooking operations. In some embodiments, more or fewer openings may be provided, for example if the module 1 includes additional arm members. In some embodiments, cooking features may be disabled when the lid 5 is removed, though in others, cooking using the module 1 may continue even when the lid 5 is removed. Cooking with the lid 5 removed for extended periods may, however, reduce the effectiveness of the cooking process.

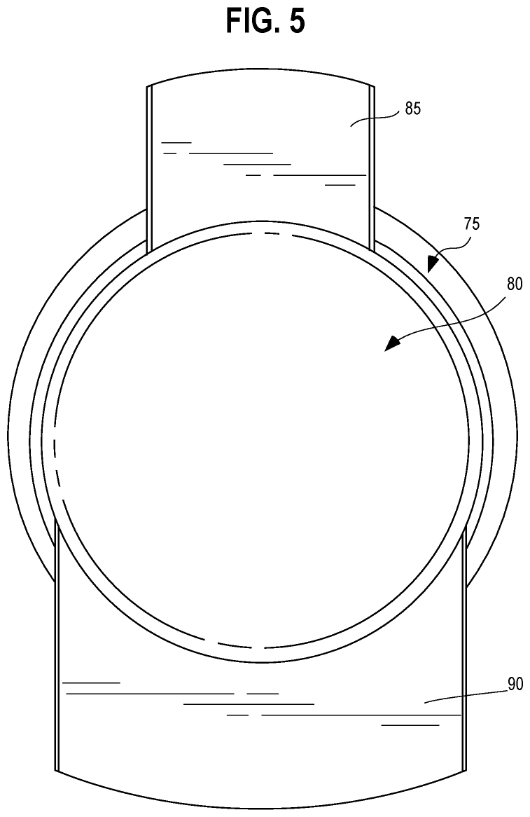

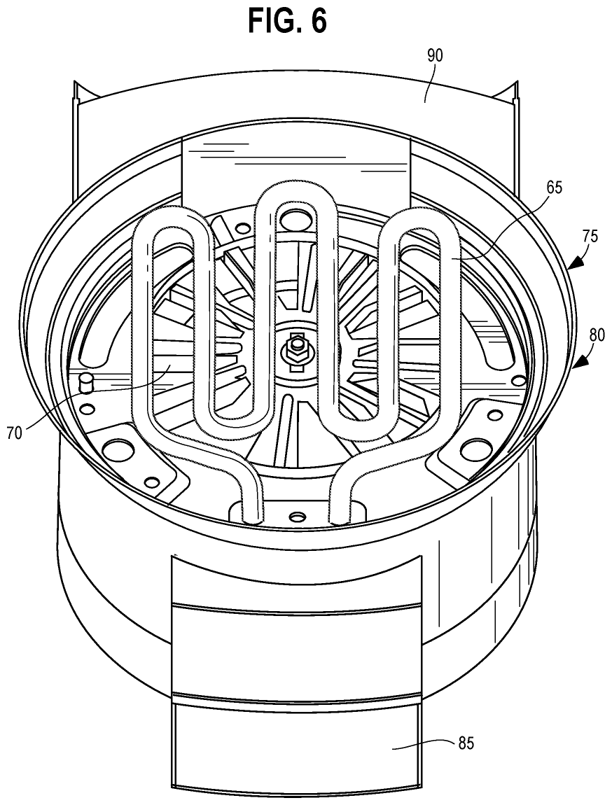

FIGS. 5 and 6 better illustrate the inner support structure 75. More particularly, FIG. 5 provides a top perspective view of the inner support structure 75, and FIG. 6 provides a bottom perspective view of the inner support structure 75 (as well as its central housing unit 80 and arm members 85, 90). A contact or a non-contact switch and associated actuator (not illustrated) may be located in or on the central housing unit 80 of the inner support structure 75, or on the flange portion 100 or on the lip portion 25. The contact or non-contact switch may engage with a lid such as the lid 5 to allow a controller such as the control panel to sense the presence of the lid. Similarly, a similar switch on the lop portion 25 or elsewhere may allow the controller to determine when the module 1 has been removed from a cooking appliance.

FIG. 6 also better illustrates the heating element 65 and the fan member 70. In some embodiments, the central housing unit 80 may house multiple fan members and/or heating elements. While the heating element 65 and the fan member 70 are contemplated as being powered by standard wall outlets, they may, in alternative embodiments be powered by batteries or other foreseeable power sources.

Turning to FIGS. 7 and 8, a grill module 95 is positioned within a vessel 100 to which the expansion module 1 and the lid 5 have been coupled. The grill module 95 preferably includes each of a reflector 105 and a grill rack 110.

The reflector 105 preferably includes an upper surface 115 and a lower surface 120. The upper surface 115 and the lower surface 120 may be made from the same reflective material as the entirety of the reflector 105, which may be a form sheet metal component, though other materials are envisioned herein. The reflector 105 is preferably supported by a floor 125 of the vessel 100. The reflector 105 may be spaced above the floor 125 at a variety of distances to achieve desired cooking. In the illustrated embodiment, a plurality of standoff feet 130 project downwardly from the lower surface 120. In the illustrated embodiment, there are four standoff feet 130, though only two are visible because the view in FIGS. 7 and 8 is a cross-section and thus half the feet 130 are “cut off” In some embodiments, more or fewer feet 130 may be provided.

In yet other embodiments, the reflector 105 and/or the feet 130 may also incorporate an adjustment mechanism to allow the user to customize the height at which the reflector 105 sits off the floor 125 of the cooking vessel 100. Increasing the distance between the reflector 105 and the floor 125 can effectively reduce the internal capacity of the vessel 100, thereby allowing for faster cooking. In yet other embodiments, means other than the feet 130 may be used to maintain the reflector 105 at a distance from the floor 125, or the feet 130 may be omitted entirely and the reflector 105 may sit directly on the floor 125.

The reflector 105 can be concave, convex, or include multiple angles to direct radiant energy and air toward the grill rack 110 (and thus the foodstuffs). The shape of the reflector 105 may further direct fat and oils away from the cooking process by collecting the fats and oils within the reflector 105 away from the grill rack 110.

Alternatively, the reflector 105 could also have slots or holes to allow the fats and oils to flow off or through the surfaces 115, 120.

The reflector 105 may also be made of significant mass to add passive heat to the grill module 95. This mass would absorb energy during the pre-heat phase of the cooking cycle, which would be useful in regulating the cavity temperature of the vessel 100.

In the illustrated embodiment, the grill rack 110 includes feet 135 that project downwardly from the grill rack 110 to space the grill rack 110 at a distance (which may vary depending on the application) from the reflector 105. Only two such feet 135 are illustrated in FIGS. 7 and 8, though more or fewer may be present in alternative embodiments. In yet other alternative embodiments, the reflector 105 may also have receiving details to allow the grill rack 110 to be supported by the reflector 105.

The grill rack 110 also may incorporate handles 140 to facilitate easy removal from the vessel 95. The illustrated embodiment includes two handles 140, each of which being half illustrated since the images of FIGS. 7 and 8 are cross-sectional views. More or fewer handles 140 may be provided in alternative embodiments.

The grill rack 110, as well as the feet 135 and the handles 140 may be a welded wire component that is like wire elements found in the prior art and thus includes slots 145 arranged within the rack 110. The slots 145 may be defined as any space that allows for communication above and below the rack 110. During the cooking process, oils and fats generated may slip through the slots 145. In alternative embodiments, the grill rack 110 could also be a formed sheet metal component with a multitude of slots to allow fat and oil from the foodstuffs being grilled to easily flow away and/or through. The grill rack 110 is preferably substantially flat for easy cooking, though it could take on other shapes in alternative embodiments.

The grill rack 110 may be made from a number of materials, and those materials may have a range of heating capacity. In some embodiments, the grill rack 110 may be a strong heat conductor and in others, it may be a weak heat conductor.

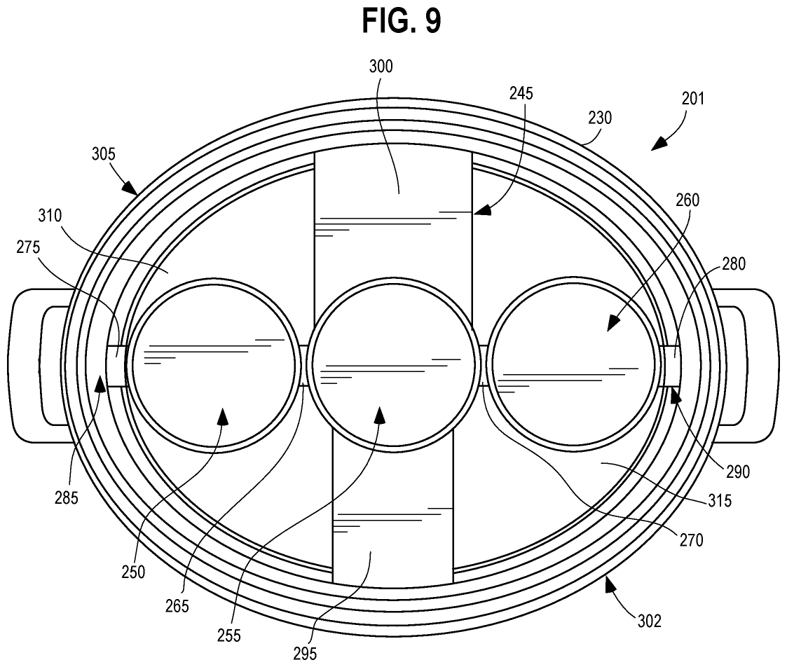

FIG. 9 illustrates an alternatively constructed multi-cooking function expansion module 201. As illustrated, the module 201 includes an outer wall 230 with an inner support structure 245 located therein that may support a first housing 250, second housing 255, third housing 260, and the mechanical and electronic components associated therewith. The housings 250, 255, 260 are generally illustrated as cylindrical, although other shapes are foreseeable. The second housing 255 is embodied as positioned between the first housing 250 and the third housing 260, though other arrangements are foreseeable. Additionally, the support structure 245 may include more or fewer housings, alternatively sized and shaped housings, etc. One or more of the housings 250, 255, 260 may receive various cooking accessories, which are described in detail below. When the accessories are received in one or more of the housings 250, 255, 260, they may carry out their intended cooking function at prescribed times for prescribed durations during a cooking cycle.

The housings 250, 255, 260 preferably include tunnel members 265, 270 that connect the housings 250, 255 and the housings 255, 260, respectively. The tunnel members 265, 270 may act as conduits for electrical and/or data communication wires or other infrastructure that assists accessories retained within the housings 250, 255, 260 to carry out their functions. Additional tunnel members 275, 280 may also be provided at end portions 285, 290 of the outer housings 250, 260, respectively to provide similar conduits for electrical and/or data communication wires and additional structural support.

The inner support structure 245 preferably includes at least one arm member(s). In the embodiment illustrated in FIG. 9, the support structure 245 includes two arm members 295, 300 that extend radially outwardly from the central housing 255 and attach to (or are integrally formed with) the outer wall 230. In one embodiment, the arm member 295 extends toward a front side 302 of the module 201 while the arm member 300 extends toward a rear side 305 of the module 1.

The support structure 245 (e.g., the arm members 295, 300 of the support structure 245) preferably supports and houses or contains heating elements, power and/or data wires, power contacts, motors, air duct channels, and the like (not illustrated) that help carry out the functions of the cooking accessories. The air ducting preferably isolates the motor cooling airflow from any convection-type airflow and may exit the module 201 via vents on the module 201. The air flow path within the module 201 and its inner support structure 245 may also incorporate an inlet channel, such as around the control panel/display, for thermal management.

The necessary cabling for controls and power may be located in the inner support structure and in communication with the components needing power. The cabling for controls and power may also be located in at least one of the arm members 295, 300. Preferably the power cord extends through the arm member 300 and exits through a power cord exit port such as that which is described above. In the illustrated embodiment, the arm member 300 is wider than the arm member 295, though in alternative embodiments that may vary.

Openings are defined by the at least one arm member(s) 295, 300 and the outer wall 230. In the illustrative embodiment, two openings 310, 315 are defined by the arm members 295, 300 and the outer wall 230. As the outer wall 230 is preferably generally vertically oriented, it may not materially reduce the size of the openings 310, 315. The openings 310, 315 provide access to a cooking vessel such as the cooking vessel 100 when a lid such as the lid 5 is removed. A user can, for example, add ingredients during various times of the cooking process. It may also allow a user to inspect the cooking process and make adjustments such as mixing ingredients without substantially disturbing the appliance's cooking operations. Or, in scenarios where the lid 5 is transparent, a user may be able to see into the vessel 100 without having to adjust the position of the module 201. In some embodiments, more or fewer openings may be provided, for example if the module 201 includes additional arm members. In some embodiments, cooking features may be disabled when the lid 5 is removed, though in others, cooking using the module 201 may continue even when the lid 5 is removed. Cooking with the lid 5 removed for extended periods may, however, reduce the effectiveness of the cooking process.

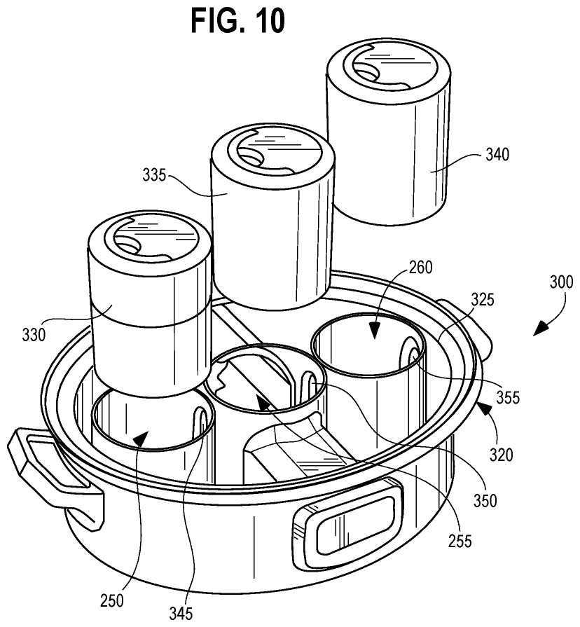

As illustrated in FIG. 10, a top portion 320 of the module 201 preferably includes a receiving flange portion 325 that is sized and shaped to receive an existing cooking appliance lid such as the lid 5 thereon. As such, the size and shape of the flange portion 325 may vary depending on the existing cooking appliance for which the module 201 has been designed to be compatible.

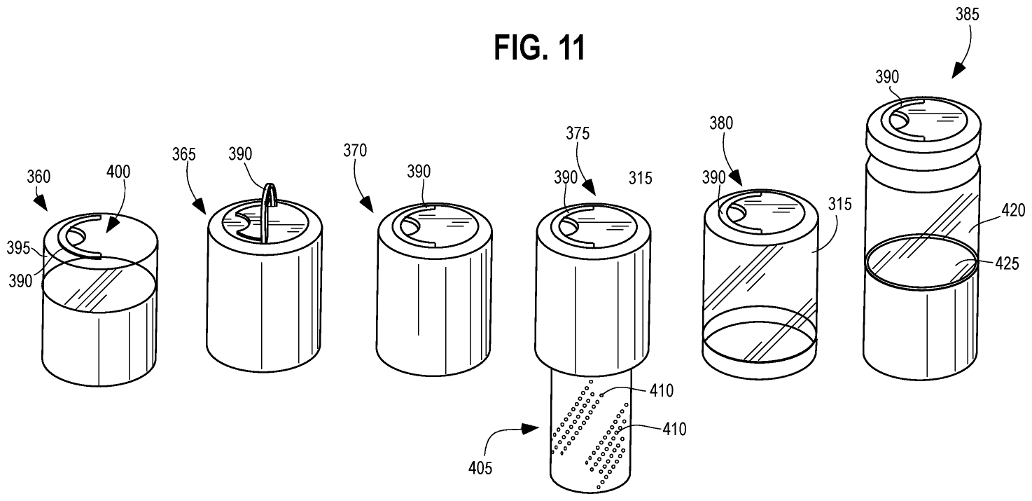

Three example cooking accessories 330, 335, 340 are provided as removed from the housings 250, 255, 260, respectively, in FIG. 10. The accessories 330, 335, 340 are examples of accessories that may be used, but they may be representative on any number of accessories including those described with respect to FIG. 11 hereinbelow. The accessories 330, 335, 340 are generally illustrated as cylindrical so that they may be received and secured within the generally cylindrical housings 250, 255, 260, though other compatible shapes are foreseeable.

In FIG. 10, power and/or data contacts 345, 350, 355 are illustrated in each of the housings 250, 255, 260, respectively. When the contacts 345, 350, 355 abut contacts (not illustrated) of the accessories 330, 335, 340, power and/or data may be transferred using known or foreseeable electronic and/or mechanical principles to the accessories 330, 335, 340 so that they may carry out their intended functions. In other embodiments, the accessories 330, 335, 340 may be “wireless” from the standpoint that they may include their own power sources (e.g., batteries), and they may be able to communicate wirelessly with a control unit that instructs the accessories 330, 335, 340 on when, for how long, at what intensity, etc., to carry out their functions.

FIG. 11 illustrates six different examples of accessories (which are not necessarily drawn to scale) that are embodied as example accessories 330, 335, 340 that can be used with the module 201 in FIG. 10. More particularly, FIG. 11 illustrates example embodiments of a steamer accessory 360, air fryer accessory 365, smoker accessory 370, sous vide accessory 375, delay add accessory 380, and a food processor accessory 385. Each of the accessories of FIG. 11 preferably include a rotatable handle 390 that may make it easier for an operator to remove an accessory from a housing of the module 201 such as the housings 250, 255, 260.

In some embodiments, such as when the accessories are not configured to be “wireless” as set forth above, each of the accessories of FIG. 11 (and other accessories not contemplated herein) preferably include contacts (not illustrated) that are configured to abut contacts 345, 350, 355 of the housings 250, 255, 260. Power and/or data may thereby be transferred via the contacts using known or foreseeable electronic and/or mechanical principles to the accessories so that they may carry out their intended functions. Such intended functions may also be carried out in particular ways since the accessories may be programmable to carry out functions at specific times and at specific intensities, as set forth below. Such programmability may be carried out by known or foreseeable computer programming techniques.

The steamer accessory 360 preferably includes a water chamber 395 as well as necessary heating elements (not illustrated) that can heat water contained in the water chamber 395. Steam generated by the steamer accessory 360 may be released from several locations on the accessory 360 but preferably near an upper portion 400 of the accessory such that is rises upwardly toward a container including the foodstuffs to be steamed.

The air fryer accessory 365 preferably includes a fan element, heating element, and ductwork and power components needed to carry out an air fryer function. The air fryer accessory 365 is preferably able to carry out air frying functions, namely circulating hot air in a convection or convection-like manner.

The smoker accessory 370 may be configured in several ways. It may include smoke “flavor pods” that when opened release smoke flavor during the cooking process. Alternatively, it may be configured as a slow-release smoke chamber that is filled with smoke before being placed in a housing and subsequently releasing the trapped smoke over time. In yet another embodiment, it may include a heating element and a wood chip chamber that may be heated by the heating element such that wet wood chips placed in the chamber emit smoke.

The sous vide accessory 375 preferably operates similarly to sous vide accessories on the market in that it may emit a constant temperature to cook foodstuffs to a uniform and exact temperature. The sous vide accessory 375 preferably includes a lower portion 405 that may be received in a vessel such as the vessel 100 during a cooking cycle. The lower portion 405 is illustrated in the embodiment of FIG. 11 as including a plurality of holes 410 such that (like a tea infuser), a desired flavor profile can be introduced by herbs, foods, and similar substances contained in the lower portion 405.

The delay add accessory 380 may be used to introduce ingredients at a desired time during a cook cycle without a user needing to open the lid 5. The delay add accessory is illustrated as including an ingredient chamber 415. The chamber 415 may include one or more ingredients, and in some embodiments more or fewer chambers 415 or compartments within the chamber 415 may be provided. The delay add accessory 380 may be programmable to release the one or more ingredients from the one or more chambers 415 (or compartments thereof) at a desired time during a cook cycle. That way, if for example a particular ingredient were prescribed to be added late in the cook cycle so that much of its flavor would remain in the ingredient itself, it could be programmed accordingly.

The food processor accessory 385 preferably includes a food chamber 420 in which foodstuffs to be processed may be placed prior to being blended, chopped, etc. by a blade assembly 425 within the food chamber 420. The blade assembly 425 is preferably powered such that upon command (either preprogrammed or manually), it may operate to blend, chop, etc. ingredients in the food chamber 420 for a certain time and intensity. After the food is processed to a desired consistency, it may be released to the cooking vessel 100 via a door or other opening.

Depending on the cooking style or recipe that an operator wishes to carry out, many permutations and combinations of accessories including those illustrated in FIG. 11 may be used with a cooking appliance. Multiple accessories of the same type may be used, or all the accessories may be different than one another. For example, if a user were to prepare smoked chicken wings, he or she may utilize the steamer accessory 360 to keep the wings moist during a cook, the air fryer accessory 365 to crisp the wings, and the smoker accessory 370 to introduce smoke flavor.

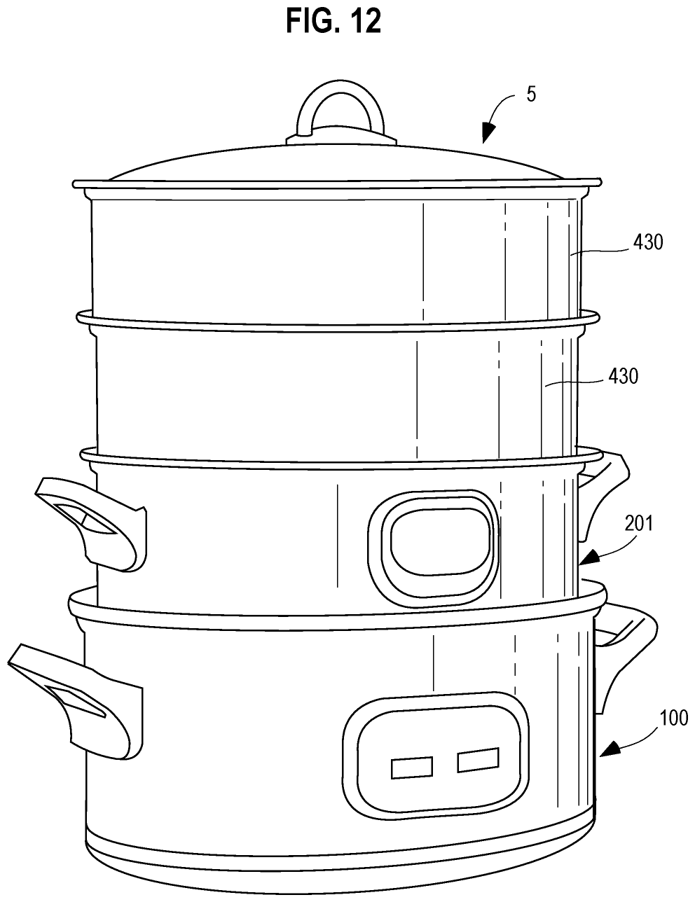

FIG. 12 illustrates an example configuration of the module 201, lid 5, and vessel 100 wherein two steamer baskets 430 are placed between the lid 5 and the module 201. The illustrated configuration may be useful, for example, when cooking steamed buns. The module 201 may include a steamer accessory 360 therein, and in some embodiments may include more steamer accessories 360. That way, when the module 201 is instructed to do so, steam may be emitted from the steamer accessories 360 upwardly into the steamer baskets 430, where the buns may be steamed. In alternative embodiments and/or alternative cooking methods, other configurations using the module 201 are foreseeable.

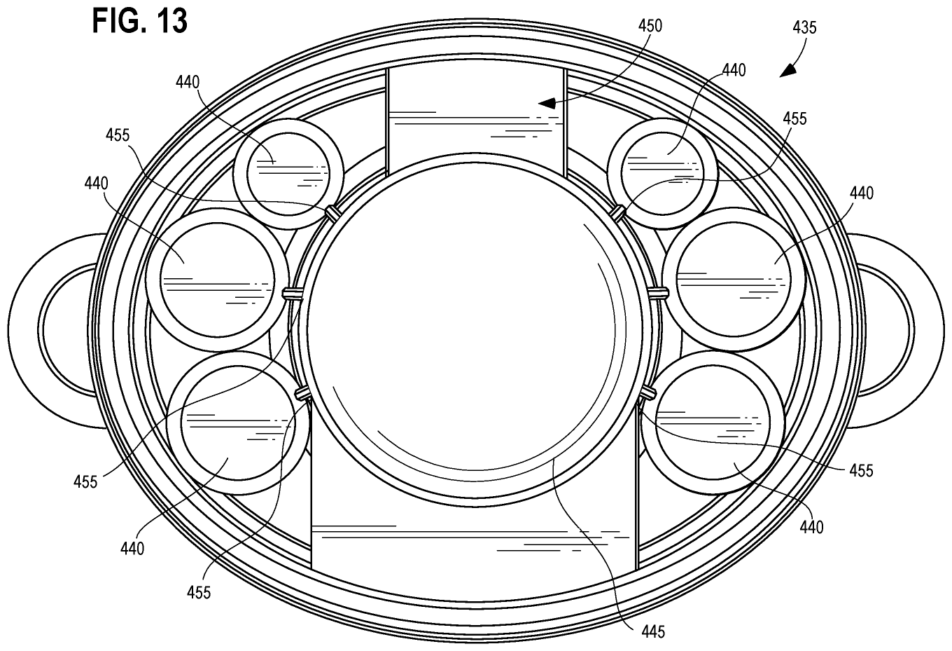

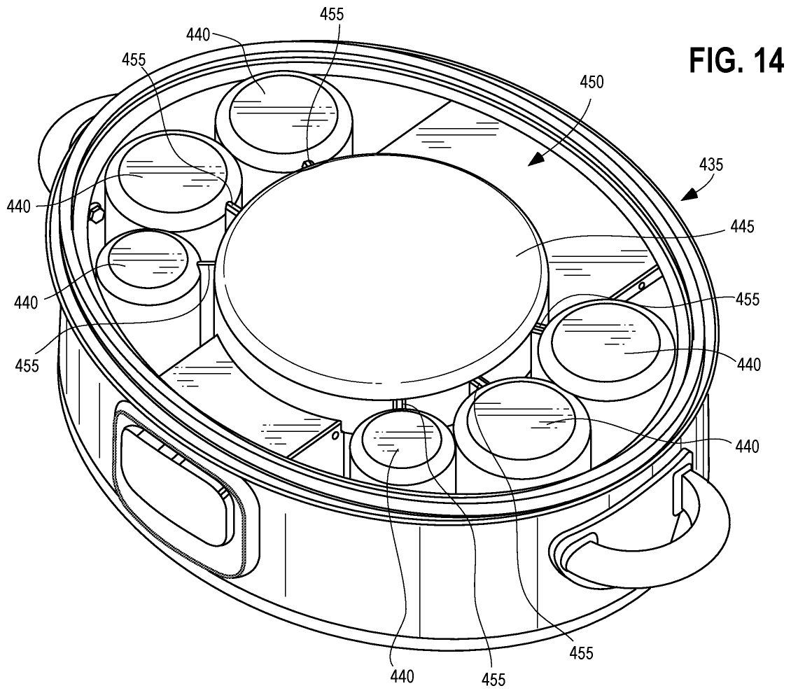

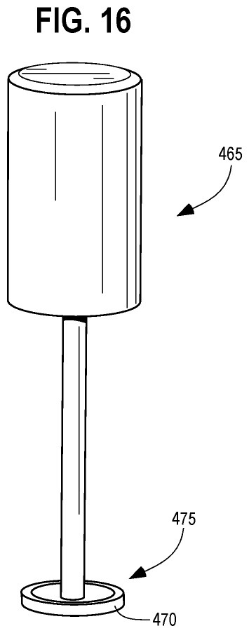

Turning to FIGS. 13 and 14, an alternatively constructed add-on expansion module 435 is provided that may be selectively engageable with a lid and vessel such as the lid 5 and the vessel 100. The module 435 includes a plurality of accessories 440 that, as shown, are arcuately positioned around a center portion 445 of an inner support structure 450 that extends across the module 435. This arcuate shape takes advantage of the curved exterior of the center portion 445 shown in FIG. 13, though other shapes and configurations are envisioned. The accessories 440 may take on many embodiments including but not limited to those illustrated and described in FIG. 11 (and/or FIG. 16). The accessories 440 are preferably retained in cavities (not illustrated) or housings that incorporate a sensor that can sense the presence of an accessory 440 and, in some embodiments, further identify what sort of accessory is retained within the cavity (e.g., steamer, sous vide, ingredient drop, etc.) for example through a code, RFID, or similar code or tag, though less intelligent cavities are also envisioned.

The center portion 445 shown in FIGS. 13 and 14 is somewhat enlarged relative to a center of the previously described inner support structure 245 of the module 201 such that it can more easily contain appropriate fans, blowers, ductwork, and heating elements to carry out an air frying function. The center portion 445 preferably does not receive an accessory such as the accessories 440, though in alternative embodiments, it may be able to do so.

Because the accessories 440 are positioned arcuately around the center portion 445 in this embodiment, more accessories 440 may be coupled to the center portion 445 and thus used than in the configuration of the module 201. For each of the accessories 440, they may be “actively” driven such that they each include their own power sources. Alternatively, they may be “passively” driven such that they are in power communication with a power source (not illustrated) associated with the module 435. In some embodiments each of the accessories 440 are linked to a power source in a cavity or housing. The accessories 440 of the module 435 may be in data communication (and in embodiments where the accessories are passively driven, in electrical communication) with the module 435 to carry out intended functions in a variety of ways. In the illustrated embodiment, connection arms 455 are provided that allow for data (and in some cases, electrical) communication between the accessories 440 and the module 435.

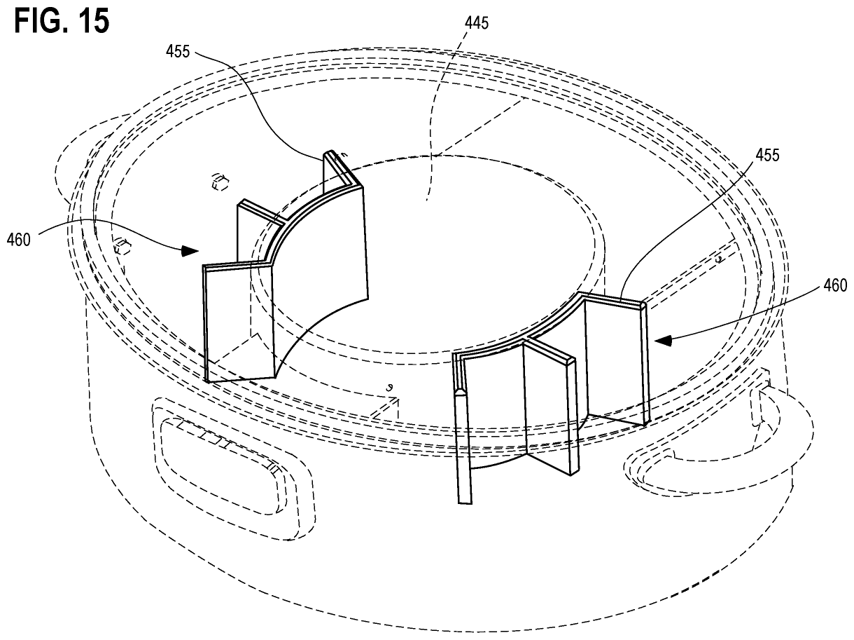

Turning to FIG. 15, the connection arms 455 are illustrated as components of crown members 460 that are used to connect the center portion 445 to the accessories 440. The crown members 460 may be configured in a number of ways, including various shapes and sizes. In any such embodiment, however, they may provide sufficient communication means for the accessories to be in data communication and/or electrical (power) communication with the module 435 so the accessories may be controlled and/or powered like the previously described accessories of FIG. 11. It will be understood, however, that such accessories could be separately powered and controlled. Alternatively, other structures similar to the crown members 460 may be provided that are able to connect the center portion 445 (and any data or electronic communication means therein) with the accessories 440.

FIG. 16 provides yet another accessory that may be used with either of the modules 201 or 435. More particularly, a stir accessory 465 is provided having a circular agitator 470 at a lower portion 475 thereof. Like the accessories described and illustrated with respect to FIG. 11, the stir accessory 465 could be received in a cavity associated with either module and controllable by a user on command or during a pre-programmed time to carry out a function associated with a particular recipe.

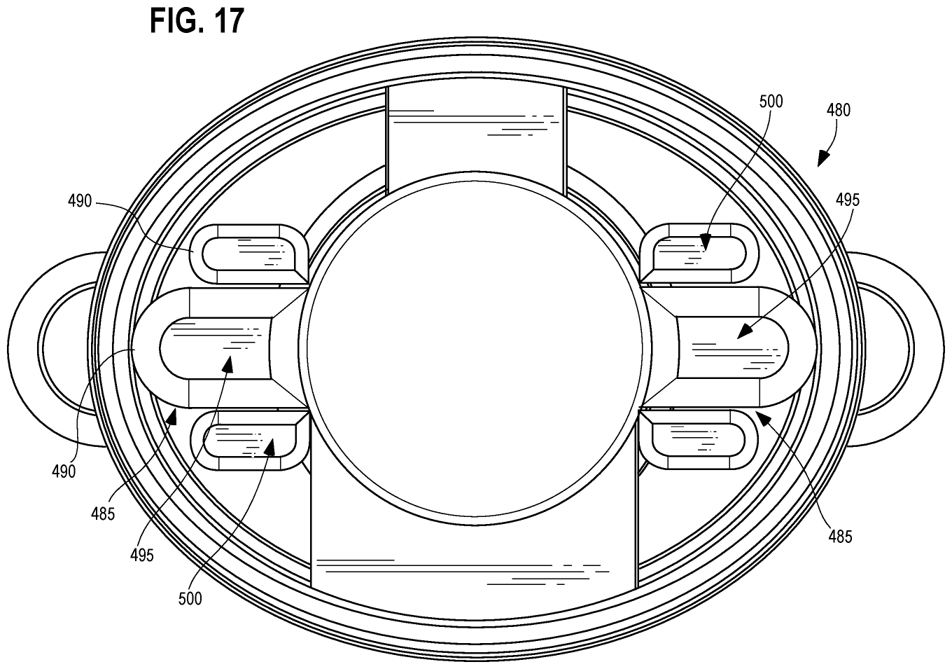

FIG. 17 provides an alternatively configured add-on expansion module 480 that functions substantially similarly to the modules 201, 435. Unlike the other modules, however, accessories 485 associated therewith take on a different shape than the cylindrical accessories previously described. Instead, the accessories 485 are provided as elongated, generally rectangular shapes with curved end portions 490. A first accessory 495 is larger than a second accessory 500, though in alternative embodiments various sized (and shaped) accessories are contemplated.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

1. A module for use with a cooking appliance having a vessel and a lid, the module comprising:
an outer support wall, the outer support wall including:
a downwardly projecting lip member that is configured to sit on a flange of the vessel;
a receiving flange portion that is sized and shaped to receive the lid;
an inner support structure including at least one arm member extending therefrom and coupled to the outer support wall; and
at least one opening defined by the outer support wall and the at least one arm member.

2. The module of claim 1, the module further comprising one or more cooking accessories configured to be received within one or more housings associated with the inner support structure.

3. The module of claim 2 wherein the one or more housings are coupled to the inner support structure.

4. The module of claim 1 wherein the inner support structure includes two arm members.

5. The module of claim 4 wherein the module includes two openings defined by the two arm members and the outer support wall.

6. The module of claim 2, wherein the module includes at least two housings coupled to the inner structure.

7. The module of claim 2, wherein the cooking accessories include one or more of an air fry accessory, steamer accessory, smoker accessory, sous vide accessory, delay add accessory, food processor accessory, and a stirrer accessory.

8. The module of claim 1, wherein the inner support structure includes a heating element and a fan member configured to blow heated air into the vessel.

9. The module of claim 2 wherein the one or more cooking accessories and the one or more housings are in electronic communication with one another.

10. The module of claim 1 further comprising a reflector positioned and located on a floor of the vessel.

11. A cooking system, the cooking system comprising:
a vessel;
a lid engageable with the vessel; and
a cooking expansion module configured to be positioned and located between the vessel and the lid, the cooking expansion module including an inner support structure coupled to an outer support wall of the cooking expansion module.

12. The cooking system of claim 11 further comprising at least one opening defined by the inner support structure and the outer support wall.

13. The cooking system of claim 11 further comprising a heating element and fan member supported by at least one of the inner support structure and the outer support wall.

14. The cooking system of claim 11 further comprising a reflector positioned and located within the vessel.

15. The cooking system of claim 11 wherein inner support structure is configured for receiving one or more cooking accessories.

16. The cooking system of claim 11 further comprising a grill rack positioned and located within the vessel.

17. A grill module for use with a cooking appliance having a vessel and a lid, the grill module comprising:
an outer support wall, the outer support wall including:
a downwardly projecting lip member that is configured to sit on a flange of the vessel;
a receiving flange portion that is sized and shaped to receive the lid;
an inner support structure including a central housing unit and at least one arm member extending therefrom and coupled to the outer support wall;
at least one opening defined by the outer support wall and the at least one arm member;
a heating element supported by at least one of the inner support structure and the outer support wall; and
a grill rack resting on a floor of the vessel.

18. The grill module of claim 17 further comprising a reflector positioned and located between the grill rack and the floor of the vessel.

19. The grill module of claim 18, the grill rack including slots through which oils and fats of a food item being cooked on the grill rack may drip.

20. The grill module of claim 17, the grill module further comprising a fan member supported by at least one of the inner support structure and the outer support wall.
